(19) United States
(12) Patent Application Publication
(10) Pub. No.: US 2009/0099904 A1
(43) Pub. Date: Apr. 16, 2009

(54) Method of Optimizing Internet Advertising

(75) Inventors: Peter Douglas Affeld, Sandy Springs, GA (US); David Carpenter, Newtown Square, PA (US)

Correspondence Address: FLASTER/GREENBERG P.C.;8 PENN CENTER, 1628 JOHN F. KENNEDY BLVD., 15TH FLOOR, PHILADELPHIA, PA, 19103, US

(73) Assignee: Numeric Analytics, L.L.C., Chadds Ford, PA (US)

(21) Appl. No.: 12/203,071

(22) Filed: Sep. 2, 2008

Related U.S. Application Data
(60) Provisional application No. 60/967,064, filed on Aug. 31, 2007.

(51) Int. Cl. G06F 19/00; G06Q 30/00; G06N 5/02

(52) U.S. Cl. 705/10; 705/14; 706/52

(57) ABSTRACT

A method of maximizing profits based on internet advertisement frequency modeling is provided herein. In the method, user data, and reach and frequency data are subjected to a modeling equation, and then coordinated and used to determine a rate at which an advertisement produces a sale of a product advertised in the advertisement for predicting an optimal advertisement frequency at which profits can be maximized in order to minimize wasted investment costs in diminishing returns from internet advertising.

### CROSS-REFERENCE TO RELATED APPLICATIONS

This application claims the benefit of priority under 35 U.S.C. § 119(e) to U.S. Provisional Patent Application No. 60/967,064 filed, Aug. 31, 2007, the entire disclosure of which is incorporated herein by reference.

Copyright or Mask Work Notice: A portion of the disclosure of this patent document contains material which is subject to (copyright or mask work) protection. The (copyright or mask work) owner has no objection to the facsimile reproduction by any-one of the patent document or the patent disclosure, as it appears in the Patent and Trademark Office patent file or records, but otherwise reserves all (copyright or mask work) rights whatsoever.

### BACKGROUND OF THE INVENTION

1. Field of the Invention

The invention involves the field of internet advertising and provides a unique method of optimizing the use of internet advertising which equates to more economic return on internet advertising investments.

2. Description of Related Art

When internet advertising began, initial uses monitored use and exposure to advertisement by website “hits,” based on website traffic and response counting. This method used metrics involving basic, non-monetized averages and evaluated only the “click-through” rate. This does not provide a realistic measure of advertising return as the number of visitors is not adequately tied to a source of revenue.

In later attempts, revenue was measured tied to the traffic on a particular site and measuring the cost per order and return on advertising spent. This was done using keywords and similar webpages and seeing which were providing more revenue than others. While comparative performance based on keywords and page hits is more useful than measuring the solely the number of hits a website receives, it has limitations in that it is still difficult to tell how much to invest in a particular website, where it is best to place the advertisement and when it is prudent to reallocate the advertisement for future advertisement dollar spending.

As a result, with the increasing use of internet advertising and ad placement, there is a need in the relevant art for a method for predicting optimal use of internet, website advertising in order to evaluate the best potential sites for a particular advertisement, the level of investment for a given website and the timing on when to reallocate the advertisement to maximize profit and economic return from internet advertising investments.

### BRIEF SUMMARY OF THE INVENTION

The invention includes a method of optimizing a benefit from an advertisement served on an internet web page using an advertisment serving frequency, comprising:

collecting page view data relating to at least one visitor, wherein each visitor has at least one view of a web page, wherein the web page has an advertisement served thereon at an advertisement serving frequency;

preparing reach frequency data based on the page view data collected from the at least one visitor, wherein the reach frequency data comprises page reach frequency data and advertisement reach frequency data;

using a predictive methodology and the reach frequency data to predict (i) a number of unique visitors that will view the web page for specified numbers of viewing occurrences as a percentage of a total of unique visitors during a selected time period and (ii) a number of unique visitors that will view the advertisement for a specified number of view occurrences of the web page for the advertisement serving frequency;

collecting conversion data for the at least one visitor;

combining the page view data and the conversion data;

determining a number of conversions and a number of non-conversions for each of the at least one visitor that viewed the advertisement for specified numbers of viewing occurrences;

calculating a conversion rate for each of the specified numbers of viewing occurrences by dividing the number of conversions for each of the at least one visitors that viewed the advertisement for each of the specified numbers of viewing occurrences by the total of the number of conversions and the number of non-conversions for each of the at least one visitors that viewed the advertisement for each of the specified numbers of viewing occurrences;

expressing the conversion rates as a function of the specified numbers of viewing occurrences of the advertisement;

determining a number of expected conversions using the reach frequency data and the conversion rates for the advertisement;

determining expected benefit from the advertisement using the number of expected conversions and the frequency of serving of the advertisement, wherein the benefit can be evaluated from the number of expected conversions; and

selecting the frequency of serving of the advertisement at which the expected benefit has a desired value.

In the method herein, the page view data may include a visitor identification, a date and time stamp of the view of the web page, and a page view identification. The page reach frequency data may be prepared by aggregating the page view data into a first data set including the page view identification, the visitor identification and a count of a number of times the visitor viewed the web page; further aggregating the first data set into a reach frequency table wherein a row in the reach frequency table represents the page identification and a count of unique visitors that viewed the identified page for each of the specified numbers of viewing occurrences during the selected time period; and calculating a percentage of each of the counts by dividing each of the counts for each of the page identifications by a total of the counts for each web page identified.

Further, in one embodiment, the above information may be used to prepare the page reach frequency histogram by demonstrating a relationship of the calculated percentages for each of the counts for each of the specified number of viewing occurrences with the specified number of viewing occurrences.

The method may also include calculating an advertisement reach frequency data distribution using equation (V):

$$v ( p , x , y ) = {{p}^{y} ( 1 - p )}^{x - y} \frac{x !}{y ! ( x - y ) !} \qquad ( V )$$

wherein ν is a percentage of all visitors viewing the web page x times, y is the number of times the advertisement is viewed and p is a percentage of the web page views having the advertisement out of a total number of the web page views, and calculating a total percentage of visitors that see the advertisement for a specified number of viewing occurrences by summing a product of the percentage of all visitors seeing the web page for given values of x using formula (VI):

$$E [ f ( v = y ) ] = {\sum }_{x = y}^{∞} g ( x ) \frac{x !}{y ! ( x - y ) !} {{p}^{y} ( 1 - p )}^{x - y} \qquad ( VI )$$

whereing g(x) represents a distribution of page views and may be estimated by a predictive methodology.

Predictive methodologies used herein for determining the distribution of page views, g(x), or for predicting the number of unique visitors that will view the web page for the specified numbers of viewing occurrences as a percentage of the total of unique visitors during a selected time period and for predicting (ii) the number of unique visitors that will view the advertisement for the specified number of view occurrences of the web page for the advertisement serving frequency, may be various methods, and in preferred embodiments herein are one of a Poisson distribution method, a cumulative gamma distribution method, and an empirical values method.

When the predictive methodology is the Poisson distribution, the methodology may comprise employing equation (I):

$$f ( x ) = \frac{{e}^{- λ} {λ}^{x}}{x} \qquad ( I )$$

wherein

ƒ(x) is a percentage of the total of unique visitors that will view the web page x times;

x is the specified number of viewing occurrences for the advertisement page by a unique visitor; and

λ is a parameter to be estimated.

In the above formula (I), λ may be estimated using a statistical technique selected from the group consisting of maximum likelihood and least squared errors.

When the predictive methodology is the gamma distribution, a probability density function may be calculated using a gamma distribution equation (II):

$$\begin{matrix}f ( x ) = \frac{{x}^{α - 1} {e}^{- x / β}}{{β}^{α} Γ ( α )} , \\ wherein & ( II ) \\ Γ = {\int }_{0}^{∞} {x}^{α - 1} {e}^{- x} d x ; & ( III )\end{matrix}$$

x is the specified number of viewing occurrences for the advertisement page by a unique visitor;

α and β are parameters to be estimated; and

the cumulative gamma function Γ is determined from a statistical table using a subroutine, wherein a percentage of the total of unique visitors that will view the web page using the cumulative gamma function are given by equation (IV):

g(x)=ƒ(x)−ƒ(x−1). (IV)

In the above calculations, α and β may be estimated using a method selected from a maximum likelihood or least squared errors.

When the predictive methodology is the empirical values method, the method may further comprise calculating actual reach frequency percentages from the reach frequency data.

In the method herein, in various embodiments, a conversion may be demonstrated by various events including revenue generated by a purchase, profit generated by a purchase, revenue generated by a subscription, a free subscription sign-up, a purchase quantity generated, a purchase indicator selected, and a click-through generated by a selection, among others.

The conversion data in the method in preferred embodiments includes a visitor identification column, a conversion date and a time stamp column, and a column including information selected from a revenue generated by a purchase, a purchase quantity, and an indicator flag indicating a conversion.

In the method of the invention herein, the step of determining the number of expected conversions may further comprise
estimating a conversion rate (c_{A}) for the advertisement a using equation (VII), wherein all values of ν are greater than 0, and 0:

$${c}_{A} = \frac{α}{1 + {e}^{( - ( β + γ {v}_{A} ) )}} - α / 2 \qquad ( VII )$$

wherein

β+γν_{A}>0;

γ>0,

α/2 is an upper bound conversion rate;

α and β together define a lower bound conversion rate;

γ expresses a slope;

α, β, and γ are be estimated by at least one of maximum likelihood or least squared errors; and

ν_{A} is a number of times a unique visitor has seen the advertisement; and
combining an advertisement specific reach frequency and the estimated conversion rates such that the number of expected conversions from a specific advertisement (s_{A}) can be calculated using equation (VIII):

$$E [ {s}_{A} ] = {\sum }_{y = 1}^{∞} E [ f ( {v}_{A} = y ) ] {c}_{A} \qquad ( VIII )$$

The method herein and other steps and variations will be better understood in conjunction with the detailed description and non-limiting examples set forth herein.

### BRIEF DESCRIPTION OF THE SEVERAL VIEWS OF THE DRAWING(S)

The foregoing summary, as well as the following detailed description of preferred embodiments of the invention, will be better understood when read in conjunction with the appended drawings. For the purpose of illustrating the invention, there is shown in the drawings embodiments that are presently preferred. It should be understood, however, that the invention is not limited to the precise arrangements and instrumentalities shown. In the drawings:

FIG. 1 is a graphical representation of a sample reach frequency histogram illustrating relationship between, on the x-axis, the percentage of people seeing a given advertisement for a given number of times (x) and, on the y-axis, the number of times a visitor views the particular advertisement;

FIG. 2 is a graphical representation, which with FIG. 3, shows how an advertisement reach frequency changes with advertisement serving frequency with all data held constant and for an advertisement which is served 10% of the time;

FIG. 3, is a graphical representation, which with FIG. 2, shows how an advertisement reach frequency changes with advertisement serving frequency with all data held constant and for an advertisement which is served 50% of the time;

FIG. 4 is a graphical representation of the relationship between conversion rate and the number of times an advertisement is viewed, demonstrating that the conversion rate may increase with the number of times the advertisement is seen, but may increase at a decreasing rate;

FIG. 5 is a graphical representation wherein the x-axis represents the number of times a page or advertisement is seen, and the y-axis represents the percentage of visitors that have seen the advertisement or web page x times such that the graph shows estimated advertisement reach frequency from Example 1 for a given web page and the page reach frequency when an advertisement is served 50% of the time, wherein the dotted line represents the actual web page reach frequency and the solid line illustrates the expected reach frequency;

FIG. 6 is a graphical representation illustrating with respect to FIG. 5 how the estimated advertisement reach frequency (solid line) for the given page of Example 1, changes with a different advertisement serving frequency, wherein the advertisement serving frequency was estimated using a 20% rate (once every fifth page view); and

FIG. 7 is a graphical representation showing the conversion rates for two advertisements shown on the same page using the data from FIGS. 5 and 6 in Example 1, wherein the x-axis represents the number of times a visitor saw the advertisement, and the y-axis represents the percentage of visitors who converted given that they had viewed the advertisement a number of times given on the x-axis, and wherein a conversion was a “click” on the advertisement served.

### DETAILED DESCRIPTION OF THE INVENTION

The first step in the process involves data collection for all web pages considered for an online display advertising campaign. As used herein, for purposes of illustrating the preferred embodiment, each step will be numbered for ease of reference, however, it should be understood based on this disclosure that additional steps may be used and optional steps omitted as noted elsewhere herein within the scope of the invention as claimed. Preferably, the method collects a minimum of three data fields for this purpose: Visitor ID (also known as cookie id), Date and Time Stamp of Page View, and Page View ID. Each row represents an observation, unique to all three fields ordered first by Page View ID, then by Visitor ID, and lastly by Date and Time Stamp of the Page View. An example of the three data fields is shown below in Table 1. In general, prediction performance can be enhanced by collecting other data as well, but such additional data collection is optional, for example, seasonal indicators for sports websites such as http://www.pga.com, wherein the website is related to golf tournaments and similar or analogous sites. Similarly, seasonal indictors can be used for retail sales organizations tracking shopping habits at different times during the year. Other optional indicators which can enhance or add to the basic data tracking can include age, geography (can be tracked through IP address or log-on information, for example), sex, income brackets and the like provided the website includes tracking of such information above and it is trackable by cookie any suitable website similar tracking method. Relevant data will vary according to client circumstances.

TABLE 1

| Visitor ID | Date | Page ID |
|---|---|---|
| 1003625 | 2007 JUL. 12 15:23:45 | 23 |
| 60891564 | 2007 JUL. 13 15:25:45 | 23 |

The next step (Step 2) in the process is organizing and aggregating the page view data collected into a reach frequency data collection. This step preferably requires aggregating the data collected in the first step, into a new data set wherein each row represents an observation listing the Page View ID, Visitor ID, and a count of times the visitor viewed the page. SQL, an extremely simple and widely known programming language can be used by one skilled in the art to carry out this step. An example of an SQL program performing this step is shown below.

The next step (Step 3) requires further aggregating the data from Step 2 into a new data set, referred to herein as a “reach frequency table,” wherein each row represents the page ID and a count of unique visitors who visited the page exactly once, twice, three times, etc. during a particular period of time, e.g. one week, one month, etc. The increments of time may be varied by situation, but preferably a highly suitable time period to use for acceptable use in measuring online ad performance is two weeks, although this should not be considered limiting. Further, as noted above, other data may be collected and incorporated into reach and frequency analysis. Again, SQL may be used to carry out this step, and an example is listed below. Finally, the counts are converted into percentage terms, by dividing each count for each page by the total counts for each page, resulting in a page reach frequency histogram. A sample reach frequency histogram is shown in FIG. 1.

Many statistical software packages and languages can be used to produce a reach and frequency table, SQL being one of the most common as is known by those skilled in the art. An example of how one skilled in the art would apply SQL code for each step follows: Step 2:

create table step2_data as
select page_id, visitor_id, count(*) as visitor_page_cnt
from step1_data
group by page_id, visitor_id

From rawdata_file
Where ad_id=23
Group by cookie_id

### Step 3:

create table step3_data as
select page_id, count (*) as reachfreq_cnt
from step2_data
group by page_id, visitor_page_count

Next, a statistical model of “reach frequency” for each page is built to produce a “predictive reach frequency” equation. This method uses this equation to predict how many unique visitors will see a specific page exactly once, twice, etc. as a percent of the total unique visitors during a future time period, based on the data available in Steps 1-3. There are many equation forms available for this purpose, but one commonly used form for modeling the number of events during a period of time is the Poisson distribution. There are three equations listed herein, however, that may be used for this purpose, although one skilled in the art, that these equations are exemplary only.

The Poisson Distribution: The Poisson equation is frequently used to statistically model the number of events during a period of time. This equation is illustrated below as equation (I):

$$f ( x ) = \frac{{e}^{- λ} {λ}^{x}}{x !} , \qquad ( I )$$

wherein f(x) is the percentage of total visitors that will see a page exactly x times, x is the number of times the page was seen by a visitor, and lambda, λ, is a parameter to be estimated. Lambda , λ, can be estimated using one of several statistical techniques, including Maximum Likelihood and Least Squared Errors. In practice, a simple grid search of lambda values will produce a suitable working model. For example, one could start with a lambda value of 0.5 and calculate Poisson values for each x value one through twenty. The result is subtracted from the actual percentage found for the same x value (known as the absolute error). Then, each absolute error is squared and the sum of the squared errors is calculated. This can be done for a range of lambda values, from 0.5 to 20 in increments of 0.1 for example. The lambda value is then preferably selected which has the lowest sum of squared errors. This parametric estimation method can be performed easily in Microsoft Excel, as well as on virtually all statistical software.

Cumulative Gamma Distribution: In practice, the cumulative gamma distribution usually performs much better than the Poisson, although the former requires the estimation of two parameters alpha (α) and beta (β). The probability density function (PDF) for the gamma distribution equation follows:

$$\begin{matrix}f ( x ) = \frac{{x}^{α - 1} {e}^{- x / β}}{{β}^{α} Γ ( α )} , \\ wherein & ( II ) \\ Γ = {\int }_{0}^{∞} {x}^{α - 1} {e}^{- x} d x ; & ( III )\end{matrix}$$

x is the number of times a page is viewed by a visitor; and
α and β are parameters to be estimated. There is no equation for the cumulative gamma function, which is the integral of the gamma PDF over values of x, but statistical tables and subroutines are widely available for SAS, Excel, Perl and the like.

The percentage of visitors expected to visit a page using the cumulative gamma function are given by:

g(x)=f(x)−f(x−1).tm (IV)

For example, to find the percentage likely to visit exactly three times, subtract the cumulative percentage to visit with x=3 (i.e., at least three times) and subtract the percentage visiting with x=2 (i.e., at least twice).

Like lambda estimation for the Poisson distribution, alpha and beta can be estimated with Maximum Likelihood or SSE. Again a simple grid search produces an effective model. Starting with alpha equal to 0.1 and beta equal to 0.5, one can calculate gamma distribution values and squared differences between calculated gamma values and actual values for each visit quantity (i.e., values of x). This can then be repeated with other values of alpha and beta (by increments of 0.1) and a combination of alpha and beta selected which minimized the SSE.

Empirical Values: Of the three examples given here, the empirical values method is the simplest. It does not require parameter estimation. One simply calculates the actual frequency percentages found in the available data, and uses the results for the following steps. While simpler, however, this method is more erratic and more vulnerable to outliers.

The next step after finishing the page reach frequency model is to calculate the “advertisement reach frequency” distribution, i.e., how many times a visitor will see a given advertisement, given a number of visits and that the advertisement is served on the page only some of the time (at a given frequency of serving). For example, if one advertisement is served only half of the time, the page is rendered, with the other half of the page renderings going to some other advertisement, the advertisement will display one distribution of advertisement views. Of those visitors who visit the page exactly once, roughly half will see the advertisement exactly once, the other half will not see the advertisement at all (and will see one of the other advertisements). Of those visitors coming to the page exactly twice, 25% will see the ad twice, 50% will see it once, and 25% will see it zero times. The frequency of advertisement views as a function of page views depends on the frequency with which an advertisement is served relative to all other advertisements that may be served instead. This relationship may be expressed as follows:

$$v ( p , x , y ) = {{p}^{y} ( 1 - p )}^{x - y} \frac{x !}{y ! ( x - y ) !} \qquad ( V )$$

wherein ν is the percentage of all visiting the page x times, y is the number of times the specific advertisement is viewed and p is the percentage of the page views that the advertisement is shown (versus all other advertisements). For example, if a visitor comes to a page 4 times, the probability that an advertisement is viewed exactly twice when the advertisement is served 20% of the time is 0.2̂2×0.8̂2×(4×3×2×1)/((2×1)×(2×1))=15.4%.

To obtain the total percentage of visitors that see a specific page at exactly 4 times, the sum is made of (i) the product of the percentage of visitors seeing the page 4 times and the percentage of those who see the advertisement 4 times and (ii) the percentage of visitors seeing the page 5 times multiplied by the percentage of those who see the advertisement 4 times, etc. Mathematically, this is expressed:

$$E [ f ( v = y ) ] = {\sum }_{x = y}^{∞} g ( x ) \frac{x !}{y ! ( x - y ) !} {{p}^{y} ( 1 - p )}^{x - y} \qquad ( VI )$$

wherein g(x) is the distribution of page views, whether estimated by Poisson, Gamma, Empirical Calculation of some other methodology. Also, the sum need not be taken much past 100 page views, as more than this usually indicates a web spider or robot.

The last equation represents the frequency distribution for the advertisement reach frequency based on a page's reach frequency. This equation enables a user to try different values of advertising serving frequency (p) to determine expected advertisement viewing frequencies.

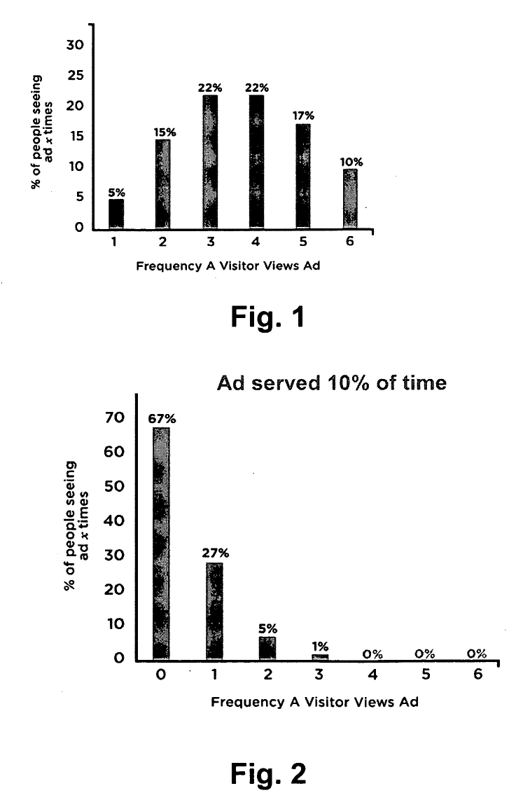

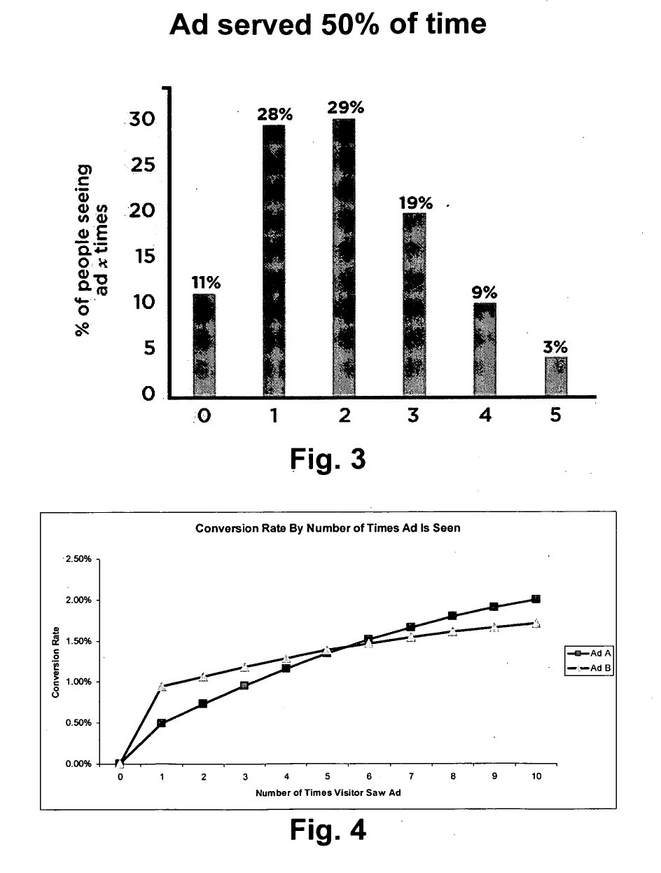

Two graphs, shown in FIGS. 2 and 3, wherein for FIG. 2, an advertisement is served 10% of time and for FIG. 3 an advertisement is served 50% of time, illustrate how the advertisement reach frequency distribution changes with different advertisement serving frequencies, when all else is constant. In FIG. 2, the page distribution is assumed to have a Poisson distribution with lambda set at 3 and the advertisement serving frequency set at 10%. Under these assumptions, 67% of the total visiting population will see the advertisement exactly zero times, 27% will see it once, etc. Under the same assumptions of page reach frequency distributed as Poisson with lambda value of 3, but an advertisement serving frequency of 50%, the overall advertisement reach frequency distribution shifts to the right as shown in FIG. 3.

While data are being collected on page views, data is also collected related to conversion. As used herein, “conversion” means broadly, including but not limited to, generating revenue from purchases, generating profit from purchases, generating revenue from subscriptions, obtaining free subscription sign-ups (such as for news sites), generating purchase quantities (e.g., the number of clothing items purchased as entered on the purchase confirmation page, the number of toys bought, etc.), purchase indicators (e.g. a simple flag indicating a purchase was made, or a repeat purchase, a renewal, etc.), and even generating simple click-throughs (for simple brand/product awareness campaigns). These data preferably includes three columns: Visitor ID, Purchase Date (Conversion Date) and Time Stamp, and either of or any of: revenue produced in the purchase, quantities purchased, or an indicator flag showing who converted and who did not. Other relevant purchase information such as session ID, geography of visitor IP address, etc., may be optionally collected but is optional for this method as it is directed to improving sales even when nothing else (such as previous visitor visitation history or demographics) is known about a visitor. The rows are unique to the Visitor ID, with the earliest purchase kept in cases where more than one purchase during the time period is made.

The conversion data is then matched and merged with the advertisement page view data as follows. On the advertisement page view data set, a visitor ID may have more than one row, potentially many rows (one for each advertisement view event). For every advertisement view row, the conversion data for those visitors that converted (purchased) something is matched. The page view and conversion dates are compared, and all advertisement views occurring past the conversion date (e.g., a purchase date) are deleted. Thus, for all visitors who converted something (purchased a product), after the visitor converts something (purchases the product), all web view data after the date of conversion related to the product being advetised is preferably removed from the collected data relating to visitors to a view of a web page.

A counter field is then created using the data collected indicating how many times an advertisement was viewed before the product was converted. For every visit observed in the collected data, one simply counts the number of visits for the visitor that have occurred prior to the current visit (observation). This is done easily with SQL. In this case, the counter (which can be automated or manual) counts the number of visits for the visitor that have occurred prior to the current visit.

Following this, the matched and merged data set is organized and aggregated with counter columns as follows. The method includes counting the number of conversions and non-conversions for visitors who have seen a particular advertisement once, twice, three times, etc. Next, the counts, counted data, are expressed as a conversion rate, i.e., conversions divided by conversions plus non-conversions. Then this data is used to produce a chart, graph or the like expressing the relationship between conversion rate and the number of times an advertisement is viewed. In general, this chart will show the conversion rate increasing with the number of times the advertisement is seen, but increasing at a decreasing rate. An example of a representative graph showing this relationship is shown in FIG. 4.

In the graph of FIG. 4, the conversion rate curves are depicted for two advertisements, A and B. The conversion rates for an advertisement are estimated using a modified logistic equation for all ν greater than 0, and 0 otherwise:

$${c}_{A} = \frac{α}{1 + {e}^{( - ( β + γ {v}_{A} ) )}} - α / 2 \qquad ( VII )$$

wherein β+γν_{A}22 0 and gamma>0. Alpha/2 has the interpretation of being the upper bound conversion rate, and the combination of alpha and beta help define the lower bound conversion rate. Gamma expresses the “slope” (note that the overall equation is nonlinear in ν, so the phrase slope has a slightly different interpretation than a slope parameter with straight lines), i.e., controls how the conversion rate changes with advertisement views.

As with the page reach frequency equations above, the parameters α, β and γ can be estimated with maximum likelihood or least squared errors using a statistical package such as SAS or SPSS, and ν_{A} is the number of times a visitor has seen the advertisement. Again, a simple grid of values will produce a working model. The range of values comprising the grid will vary by situation, but in general, the alpha variable should be estimated in the neighborhood of values indicating the lowest conversion rate (around the values found at 1 advertisement viewing), beta can start at −3 and increase be increments of 0.1 to +3, and gamma (which should be positive) can start at 0.001 and increase by increments of 0.000 1 to 0.1. Note that all parameters, especially gamma, will depend on the overall scale of conversion rates. For example, purchasing an expensive item like a car online will tend to show a much lower overall conversion rate than a simple click-through.

The total number of expected conversions from a specific advertisement is then calculated by combining the advertisement specific reach frequency and the conversion rate. Thus, the total number of expected conversions from a specific advertisement can be calculated, for example, by combining the advertisement specific reach frequency and the conversion rate using a suitable equation such as the equation below. This equation provides desirable properties in that as a probability, it never exceeds 1 nor goes below 0, and it is monotonically increasing:

$$E [ {s}_{A} ] = {\sum }_{y = 1}^{∞} E [ f ( {v}_{A} = y ) ] {c}_{A} \qquad ( VIII )$$

The total expected profit is then expressed as a function of serving frequency of the advertisement. The benefit of conversion herein is identified as “profit,” as that is the usual benefit of a conversion, however, it should be understood that the term profit herein also can include within its scope according to the invention other beneficial effects achieved by conversion, e.g., increased overall sales, enhanced sales quantities, number of indicators, click-throughs. It is to be noted herein that “profit” is meant in a very general sense, and is not necessarily limited to pecuniary profit. For example, if the dollar profit from adding an additional subscriber to a network is not available, profit may be measured as the additional revenue from an added paid subscription or simply the incremental subscriptions (expressed in terms of unit accounts) added when using the method over not using the method.

The total expected profit may be expressed as a function of serving frequency of the advertisement, for example, in graphical or other suitable format. For example, the total expected profit from a specific advertisement is the profit produced by a conversion (e.g., sale) of the product multiplied by the total expected conversions (sales) from the advertisement. Since this calculation depends on, and varies with the advertisement serving frequency, total expected profit can be expressed as a function of the advertisement serving frequency as follows:

$$E [ {Π}_{A} ] = {π}_{A} {\sum }_{y = 1}^{∞} {c}_{A} {\sum }_{x = 1}^{∞} \frac{{e}^{- λ} {λ}^{x}}{x !} \frac{x !}{( x - y ) !} {{p}_{A}^{y} ( 1 - {p}_{A} )}^{x - y} \qquad ( IX )$$

While such probability calculations are mathematically known, the present method is novel in that the probabilities of specific values (advertisement viewing frequencies) can be modeled with the reach frequency methods noted above. The choice of p_{A} (as defined above) that maximizes the above equation is found through a grid search of possible values. To identify the profit maximizing value of the percentage of all advertisements dedicated to advertisement A, one skilled in the art would choose a set of values of p_{A} and calculate the profits accordingly. The value is preferably chosen so as to produce the greatest profit or maximum benefit from conversion.

For online display advertisers, e.g., clothing retailers buying impressions on a news website, the optimal number of impressions is found where the marginal revenue (or profit) from impressions brought equals the marginal cost. Marginal revenue (or profit) can be estimated using the profit equation above. The analytic structure of the equations yields a downward sloping marginal revenue (profit) curve. This will be explained with the below example, which is not intended to be limiting.

For a range of impression values, e.g., 100,000 up to the total inventory available on a webpage, one would calculate the total expected conversions in increments of 100,000. For each incremental volume, the advertisement serving frequency is simply calculated as the impression volume bought divided by the total available, e.g., if 1,000,000 impressions are bought for an advertisement out of a total of 10,000,000 available impressions in inventory, the advertisement serving frequency is 10%.

The marginal revenue is the change in total revenue produced by one of the 100,000 incremental changes in impression volume. The marginal cost of impressions is generally a straight line (usually expressed by the publisher as a “cost per thousand” impressions). The overall impression volume where the increase in total revenue (profit) of 100,000 incremental impressions bought equals the cost of the 100,000 impressions bought indicates the profit maximizing impression volume.

When this method is applied to a user's own site and there is no explicit impression cost, an opportunity cost of a page view can be used instead. This value will depend on how the user defines the opportunity cost of the page view. If such a value is not available, then the method can still optimize the rotation of advertisemetns by determining the frequency that maximizes overall conversions. To do this, simply calculate the total conversions from all ads using a grid of advertisement serving frequencies. To do this, one calculates the total conversions from all advertisements using a grid of advertisement serving frequencies, e.g., advertisement A at 90%, advertisement B at 10%, followed by advertisement A at 80%, advertisement B at 20%, etc. The combination yielding the highest conversion is optimal.

For only two advertisements in rotation, the advertisement serving frequency of one advertisement implies the advertisement serving frequency of the other advertisement (i.e. one minus the advertisement serving frequency of the first advertisement). Total profit from both advertisements can then be predicted as the sum of profit for both advertisements as a function of the advertisement serving frequency for one of the advertisements. This can be expressed as a simple single column array as shown in Table 2 wherein the total visitors are for example, 20,000:

TABLE 2

| Serving | Conver- | Conver- | “Profit” | “Profit” | Total |
|---|---|---|---|---|---|
| Frequency | sion | sion | (e.g. Sales) | (e.g. Sales) | “Profit” |
| of Ad A | Rate A | Rate B | from Ad A | from Ad B | (Sales) |
| 0% | 0% | 1.27% | 0.00 | 254.03 | 254.03 |
| 10% | 0.18% | 1.23% | 35.90 | 245.01 | 280.92 |
| 20% | 0.33% | 1.17% | 66.25 | 234.93 | 301.18 |
| 30% | 0.46% | 1.12% | 92.61 | 223.37 | 315.98 |
| 40% | 0.58% | 1.05% | 116.06 | 209.77 | 325.82 |
| 50% | 0.69% | 0.97% | 137.36 | 193.26 | 330.63 |
| 60% | 0.79% | 0.86% | 157.05 | 172.63 | 329.68 |
| 70% | 0.88% | 0.73% | 175.47 | 146.11 | 321.58 |
| 80% | 0.96% | 0.56% | 192.87 | 111.16 | 304.03 |
| 90% | 1.05% | 0.32% | 209.42 | 64.17 | 273.59 |
| 100% | 1.13% | 0.00% | 225.22 | 0.00 | 225.22 |

Finally, the advertisement serving frequency in the array is selected that provides the highest or otherwise desired expected total profit (highest sales, etc.). Note that if a simple A/B “winner” vs. “loser” approach were used instead of a variable frequency approach, B would have been selected for all advertisement serving, resulting in 254 sales a decrease of more than 76 units (330.63 units with a 50%/50% A/B split vs. 254.03 with the “winner” B only). Thus, the method of the invention contributes to an increase in expected sales for this example of 30%.

This increase in sales is produced by shifting impressions from marginally less productive ads to marginally more productive ads, regardless of what the average conversion rates are. Averages tend to obscure the material details of ad performance, details that are described and leveraged in this method.

The invention will now be further illustrated with respect to the following non-limiting example.

### EXAMPLE 1

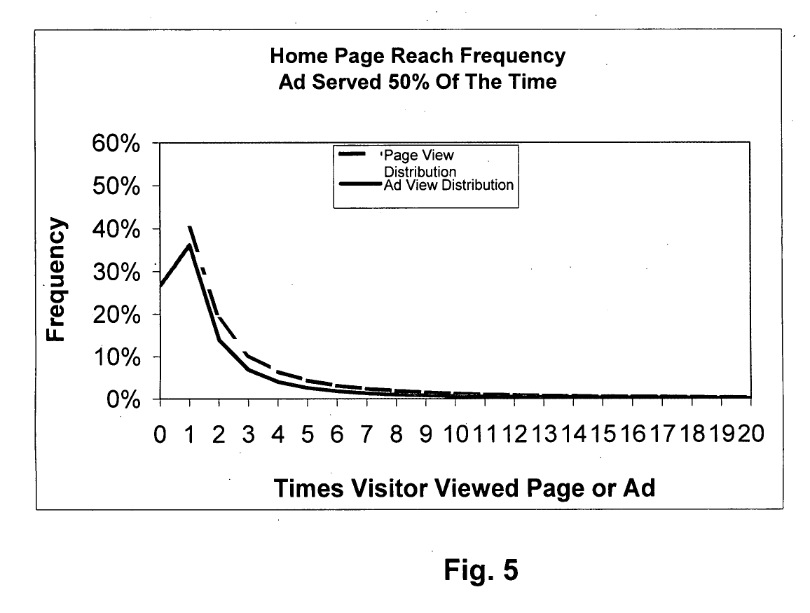

With reference to FIG. 5, a graph is shown that illustrates the steps of the method involved with estimating advertisement reach frequency for a given web page, as well as page reach frequency and advertisement serve frequency. The x-axis represents the number of times a page or advertisement is seen, and the y-axis represents the percentage of visitors that have seen the advertisement or web page x times.

Data were collected from advertisement serve logs to show pages and advertisements viewed by visitor. Page and advertisement view counts were made using a PERL script (although SQL could have easily performed the counts as well, as noted elsewhere herein, which helps to illustrate the versatility of the method.

In FIG. 5, the dotted line represents the actual web page reach frequency. For example, about 40% of the visitors viewed the home page exactly once (implying 60% viewed more than once), about 10% viewed it exactly 3 times, and so on. The line in this example is not modeled, illustrating the empirical method explained earlier.

The solid line in FIG. 5 illustrates the expected reach frequency for a given advertisement served on the same home page 50% of the time, using the method. For example, about 28% of visitors to this home page will not see the ad at all (i.e., 0 advertisement views), while about 7% will see the advertisement exactly 3 times. These percentages (as well as all the others of the entire distribution) will vary with the page view reach frequency as well as the advertisement serve frequency.

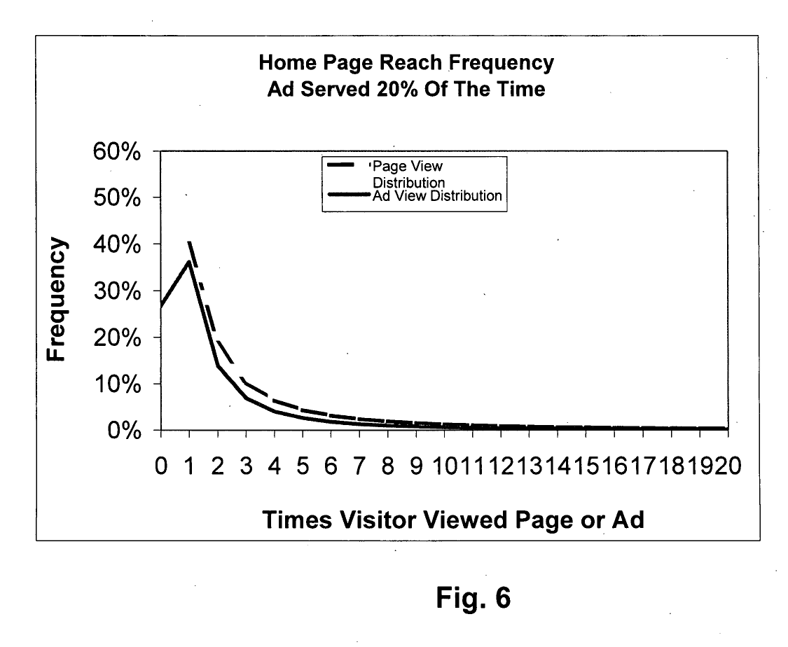

Now turning to FIG. 6, a graph is provided illustrating how the solid line, the estimated advertisement reach frequency for a given page, changes with a different advertisement serve frequency, using the method. In FIG. 5, advertisement reach frequency was calculated using the method at a 50% advertisement serve frequency. In FIG. 6, the advertisement serve frequency is estimated using a 20% rate (once every fifth page view). Since the advertisement is served less frequently (20% vs. 50%), the advertisement view frequency shifts to the left, illustrating how less often visitors to the page will see this specific advertisement. For example, at a 50% advertisement serve frequency, only 28% of page viewers are estimated to see the ad exactly 0 times (i.e., do not see the advertisement at all), whereas at a 20% advertisement serve frequency, more than 55% see it 0 times.

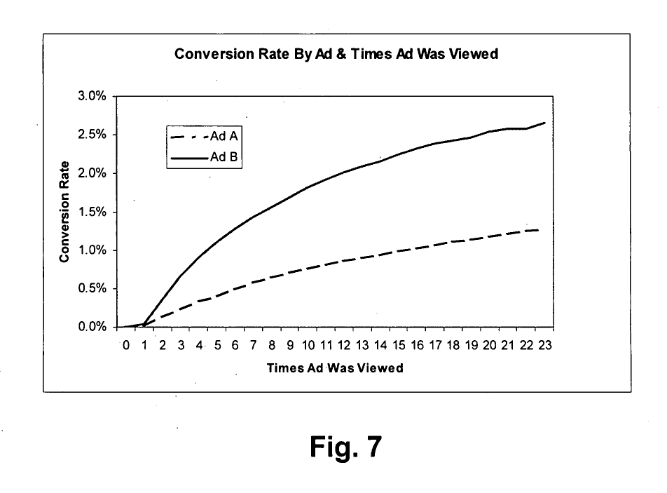

In FIG. 7, the graph shows the conversion rate for two advertisements shown on the same page. The x-axis represents the number of times a visitor saw the advertisement, and the y-axis represents the percentage of visitors who converted given that they had viewed the advertisement a number of times given on the x-axis. For example, visitors who saw advertisement A (dotted line) exactly 5 times converted at around a 4% rate, while those who saw advertisement B (solid line) converted at slightly above a 1% rate. In this Example, the data were collected from advertisement serve logs, and conversions were defined as “clicks” on the advertisement served.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A method of optimizing a benefit from an advertisement served on an internet web page using an advertisment serving frequency, comprising:
collecting page view data relating to at least one visitor, wherein each visitor has at least one view of a web page, wherein the web page has an advertisement served thereon at an advertisement serving frequency;
preparing reach frequency data based on the page view data collected from the at least one visitor, wherein the reach frequency data comprises page reach frequency data and advertisement reach frequency data;
using a predictive methodology and the reach frequency data to predict (i) a number of unique visitors that will view the web page for specified numbers of viewing occurrences as a percentage of a total of unique visitors during a selected time period and (ii) a number of unique visitors that will view the advertisement for a specified number of view occurrences of the web page for the advertisement serving frequency;
collecting conversion data for the at least one visitor;
combining the page view data and the conversion data;
determining a number of conversions and a number of non-conversions for each of the at least one visitor that viewed the advertisement for specified numbers of viewing occurrences;
calculating a conversion rate for each of the specified numbers of viewing occurrences by dividing the number of conversions for each of the at least one visitors that viewed the advertisement for each of the specified numbers of viewing occurrences by the total of the number of conversions and the number of non-conversions for each of the at least one visitors that viewed the advertisement for each of the specified numbers of viewing occurrences;
expressing the conversion rates as a function of the specified numbers of viewing occurrences of the advertisement;
determining a number of expected conversions using the reach frequency data and the conversion rates for the advertisement;
determining expected benefit from the advertisement using the number of expected conversions and the frequency of serving of the advertisement, wherein the benefit can be evaluated from the number of expected conversions; and
selecting the frequency of serving of the advertisement at which the expected benefit has a desired value.

2. The method according to claim 1, wherein the page view data comprises a visitor identification, a date and time stamp of the view of the web page, and a page view identification.

3. The method according to claim 2, wherein the page reach frequency data is prepared by
aggregating the page view data into a first data set including the page view identification, the visitor identification and a count of a number of times the visitor viewed the web page;
further aggregating the first data set into a reach frequency table wherein a row in the reach frequency table represents the page identification and a count of unique visitors that viewed the identified page for each of the specified numbers of viewing occurrences during the selected time period; and
calculating a percentage of each of the counts by dividing each of the counts for each of the page identifications by a total of the counts for each web page identified.

4. The method according to claim 3, wherein a page reach frequency histogram is prepared demonstrating a relationship of the calculated percentages for each of the counts for each of the specified number of viewing occurrences with the specified number of viewing occurrences.

5. The method according to claim 2, further comprising calculating an advertisement reach frequency data distribution using equation (V):
$$v ( p , x , y ) = {{p}^{y} ( 1 - p )}^{x - y} \frac{x !}{y ! ( x - y ) !} \qquad ( V )$$
wherein ν is a percentage of all visitors viewing the web page x times, y is the number of times the advertisement is viewed and p is a percentage of the web page views having the advertisement out of a total number of the web page views, and calculating a total percentage of visitors that see the advertisement for a specified number of viewing occurrences by summing a product of the percentage of all visitors seeing the web page for given values of x using formula (VI):
$$E [ f ( v = y ) ] = {\sum }_{x = y}^{∞} g ( x ) \frac{x !}{y ! ( x - y ) !} {{p}^{y} ( 1 - p )}^{x - y} \qquad ( VI )$$
whereing g(x) represents a distribution of page views and may be estimated by a predictive methodology.

6. The method according to claim 5, wherein the predictive methodology for determining the distribution of page views, g(x), is selected from the group consisting of a Poisson distribution method, a cumulative gamma distribution method, and an empirical values method

7. The method according to claim 1, wherein the predictive methodology for predicting the number of unique visitors that will view the web page for the specified numbers of viewing occurrences as a percentage of the total of unique visitors during a selected time period and for predicting (ii) the number of unique visitors that will view the advertisement for the specified number of view occurrences of the web page for the advertisement serving frequency is selected from the group consisting of a Poisson distribution method, a cumulative gamma distribution method, and an empirical values method.

8. The method according ot claim 7, wherein the predictive methodology is the Poisson distribution, and the methodology comprises employing equation (I):
$$f ( x ) = \frac{{e}^{- λ} {λ}^{x}}{x !} \qquad ( I )$$
wherein
ƒ(x) is a percentage of the total of unique visitors that will view the web page x times;
x is the specified number of viewing occurrences for the advertisement page by a unique visitor; and
λ is a parameter to be estimated.

9. The method according to claim 8, wherein λ is estimated using a statistical technique selected from the group consisting of maximum likelihood and least squared errors.

10. The method according ot claim 7, wherein the predictive methodology is the gamma distribution and a probability density function is calculated using a gamma distribution equation (II):
$$\begin{matrix}f ( x ) = \frac{{x}^{α - 1} {e}^{- x / β}}{{β}^{α} Γ ( α )} , \\ wherein & ( II ) \\ Γ = {\int }_{0}^{∞} {x}^{α - 1} {e}^{- x} d x ; & ( III )\end{matrix}$$
x is the specified number of viewing occurrences for the advertisement page by a unique visitor;
α and β are parameters to be estimated; and
the cumulative gamma function Γ is determined from a statistical table using a subroutine, wherein a percentage of the total of unique visitors that will view the web page using the cumulative gamma function are given by equation (IV):
g(x)=ƒ(x)−ƒ(x−1). (IV)

11. The method according to claim 10, wherein α and β are estimated using a method selected from a maximum likelihood or least squared errors.

12. The method according to claim 7, wherein the predictive methodology is the empirical values method and the method further comprises calculating actual reach frequency percentages from the reach frequency data.

13. The method according to claim 1, wherein a conversion is one of revenue generated by a purchase, profit generated by a purchase, revenue generated by a subscription, a free subscription sign-up, a purchase quantity generated, a purchase indicator selected, and a click-through generated by a selection.

14. The method according to claim 1, wherein the conversion data includes a visitor identification column, a conversion date and a time stamp column, and a column including information selected from a revenue generated by a purchase, a purchase quantity, and an indicator flag indicating a conversion.

15. The method according to claim 1, wherein the step of determining the number of expected conversions further comprises
estimating a conversion rate (c_{A}) for the advertisement a using equation (VII), wherein all values of ν are greater than 0, and 0:
$${c}_{A} = \frac{α}{1 + {e}^{( - ( β + γ {v}_{A} ) )}} - α / 2 \qquad ( VII )$$
wherein
β+γν_{A}>0;
γ>0,
α/2 is an upper bound conversion rate;
α and β together define a lower bound conversion rate;
γ expresses a slope;
α, β, and γ are be estimated by at least one of maximum likelihood or least squared errors; and
ν_{A} is a number of times a unique visitor has seen the advertisement; and
combining an advertisement specific reach frequency and the estimated conversion rates such that the number of expected conversions from a specific advertisement (s_{A}) can be calculated using equation (VIII):
$$E [ {s}_{A} ] = {\sum }_{y = 1}^{∞} E [ f ( {v}_{A} = y ) ] {c}_{A} \qquad ( VIII )$$
